(19) United States
(12) Patent Application Publication
(10) Pub. No.: US 2025/0253423 A1
(43) Pub. Date: Aug. 7, 2025

(54) METHOD FOR SEPARATING THE ELECTRODE MATERIALS FROM THE CURRENT COLLECTOR IN ELECTRODES FROM SPENT LITHIUM-ION BATTERIES

(71) Applicant: SOLVAY SPECIALTY POLYMERS ITALY S.P.A., Bollate (Milano) (IT)

(72) Inventors: Fiorenza D'aprile, Nova Milanese Milano (IT); Valeriy Kapelyushko, Alessandria (AL) (IT); Marco Avataneo, Milano (MI) (IT); Letanzio Bragante, DUE CARRARE (PD) (IT)

(73) Assignee: SOLVAY SPECIALTY POLYMERS ITALY S.P.A., Bollate (Milano) (IT)

(21) Appl. No.: 18/853,324

(22) PCT Filed: Mar. 30, 2023
(86) PCT No.: PCT/EP2023/058258

§ 371 Date: Oct. 1, 2024

(30) Foreign Application Priority Data
Apr. 1, 2022 (EP) 22166304.0

(51) Int. Cl. H01M 10/54; C22B 7/00; C22B 15/00; C22B 21/00

(52) U.S. Cl. CPC H01M 10/54; C22B 7/001; C22B 15/00; C22B 21/0069

(57) ABSTRACT

The present invention relates to a method for separating the electrode materials from the current collector in a battery electrode, said method comprising: a—providing at least one electrode said electrode comprising a current collector and a layer of electrode material adhered onto said current collector, said layer of electrode material comprising electro active materials in powder form and a binder b—contacting said electrode to a gas or a supercritical fluid at a pressure of (60) to 300 bar, c—rapidly decreasing the pressure of said gas or supercritical fluid of at least (60) bar within (30) seconds or less thereby causing rapid decompression of said gas.

### TECHNICAL FIELD

This application claims priority from the patent application filed on 1 Apr. 2022 in EUROPE with Nr 22166304.0, the whole content of this application being incorporated herein by reference for all purposes.

The invention pertains to a method for separating the electrode materials from the current collector in an electrode of a battery, typically a secondary battery. The method includes subjecting the electrode to a permeating gas at high pressure for a sufficient amount of time for the gas to permeate the binder and the pores in the electrode material, and, in a subsequent step, quickly releasing the pressure. Upon the release of pressure the absorbed gas rapidly decompresses causing a complete separation of the electrode material from the current collector.

### BACKGROUND ART

The growing use of rechargeable batteries (also known as “secondary batteries”), typically Li-ion batteries, to power electric and electronic equipment including electric vehicles has increased the need to develop effective processes to recover the active materials from spent batteries in order to reuse them in new or regenerated batteries.

One critical aspect that any battery recycling process must face, before the material recovery can even start, is the separation of the battery in its constituent materials. The present invention relates specifically to an improved method for separating the electrode materials from the current collector.

As known to a skilled person, electrodes in rechargeable batteries typically consist of a thin metallic foil called “current collector” on which a layer of electrode materials is applied and adhered thereto via e.g. casting, printing or roll coating. This “electrode material” is a composition predominantly comprising powdery electro active materials (i.e. the components which actively participate to the energy transfer) in powder form and a binder i.e. a matrix, typically a thermoplastic matrix, which keeps the active materials together and provides the necessary adhesion to the current collector. The electrode material can also contain other optional components such as materials to enhance conductivity and/or control viscosity. Current commercial batteries typically use graphite as electro active material in the anode, and mixed oxides and salts containing lithium as electro active compounds in the cathode. The electrode material and in particular the cathode material is by far the most valuable component to be recycled in a battery and therefore significant efforts have been devoted to this scope. Many processes which have been described and practically applied for recovering the electro active materials of a spent battery typically start with shredding the battery modules or the electrodes in small pieces. This shredding step avoids the complexity of taking the battery components apart. However, as mentioned in “Lithium ion battery recycling using high-intensity Ultrasonication” (Lei and others, “Green Chem., 2021, 23, 4710-4715”): “. . . shredded components are difficult to separate into the individual components with sufficient purity to form new battery materials. It has recently been shown that electrode separation rather than battery shredding can significantly improve the purity of the products obtained, and therefore the process economics”.

The same article suggests that the use of ultrasounds may help breaking the adhesive bonds between the electrode materials and the current collector even allowing the recovery of the current collector in intact form, however such methods are still not completely industrially developed and there is still a continuous needs for developing additional methods for recovering the electrode materials without shredding the battery, to be used alone or in combination in order to achieve the most efficient and green recovery of electrode materials.

CN109103536 published on 28 Dec. 2018 describes a method for recycling the active materials in a Li Ion battery wherein the active material is first removed from the current collector and then extracted with supercritical CO₂.

### SUMMARY OF INVENTION

The present invention relates to a method for separating the electrode materials from the current collector in a battery electrode, said method comprising:
a—providing at least one electrode said electrode comprising a current collector and a layer of electrode material adhered onto said current collector, said layer of electrode material comprising electro active materials in powder form and a binder;
b—contacting said electrode to a gas or a supercritical fluid at a pressure of 60 to 300 bar,
c—rapidly decreasing the pressure of said gas or supercritical fluid of at least 60 bar within 30 seconds or less thereby causing rapid decompression of said gas.

### DETAILED DESCRIPTION OF THE INVENTION

The method of the present invention is a method for separating the electrode materials from the current collector in an electrode from a battery. Such method is particularly useful when the battery is a rechargeable battery which has reached its end of life and is, in other words, a “spent” battery, i.e. a battery which cannot be recharged anymore and/or cannot provide a sufficient amount of energy for a sufficient amount of time when recharged. In particular this method can be applied to electrodes recovered from spent Li-ion batteries which are nowadays the majority of the rechargeable batteries used in the world, but it can also be applied to batteries from future generations as long as their electrodes comprise a metallic foil as current collector and a layer of electrode material which in turns comprise electro active components and a binder.

As mentioned in the “Background” section of this document, the most common processes to recover valuable materials from spent batteries include shredding of the battery in small pieces, and then attempting to selectively dissolve or filter out the individual components using a combination of hydrometallurgical processes, however, as it can be read in the recent article “A critical review of current technologies for the liberation of electrode” (Science of the Total Environment 766 (2021) 142382—Elsevier B. V.) there are still many competing methods, each one with its advantages and disadvantages, and the biggest challenge still resides in recovering materials which are sufficiently pure for being reused in new batteries, with a low environmental impact and a cost which is competitive with using new materials instead of recovered ones. As it can be appreciated from the cited article, as of today, a “standard” method for recycling materials from spent batteries has not yet been developed.

The method of the present invention is expected to provide a useful contribution in one of the critical parts of the recovery process i.e. the separation of the current collector from the electrode materials.

The first step in the method of the invention is to provide at least one electrode, typically from a spent secondary battery. This can be easily achieved by mechanically dismantling a battery following methods known in the art. A typical battery includes a battery case in which one or more battery cells are contained. An individual cell typically comprises a positive electrode, a negative electrode and a separation membrane. The electrodes are typically in the form of rectangular sheets which are rolled or folded in order to form a cell. The review article cited above (Science of the Total Environment 766 (2021) 142382—Elsevier B. V.), for example, provides some information on the common general knowledge in the field as far as the mechanical disassembly of batteries is concerned.

An electrode for use in the present invention typically comprises a metal foil as the current collector which is coated with a layer of electrode material. Typical thickness of the current collector film is 5-30 micrometers, while the typical thickness of a coating of electrode material is from 50 to 300 micrometers.

The nature of the metal foil to be used as current collector depends on whether the electrode is a positive electrode or a negative electrode. Should the electrode of the invention be a positive electrode, the metal foil typically comprises, preferably consists of, at least one metal selected from the group consisting of aluminum (Al), nickel (Ni), titanium (Ti), iron (Fe) and alloys thereof. Preferred current collector for a positive electrode is an Al foil. Should the electrode of the invention be a negative electrode, the metal foil typically comprises, preferably consists of, silicon (Si) or at least one metal selected from the group consisting of lithium (Li), sodium (Na), zinc (Zn), magnesium (Mg), copper (Cu) and alloys thereof. Preferred current collector for a negative electrode is a Cu foil.

The electrode material composition is constituted for the most part by electro active materials, mixed with a minor amount of binder. Optionally other ingredients may be present such as materials to enhance conductivity (typically graphite).

The electro active materials are different when the electrode is a cathode or an anode.

The electro active materials for a cathode are typically selected from metallic oxides and salts including Li, typically these are mixed oxides and salts including also other metals such as Co, Mn, Ni, Fe.

Preferably metallic oxides and salts for a cathode material for a Lithium-ion secondary battery, may comprise one or more lithium containing compounds selected from:
(i) metal chalcogenides of formula LiMQ₂, wherein M is at least one metal selected from transition metals, preferably from Co, Ni, Fe, Mn, Cr and V and Q is a chalcogen preferably selected from as O or S. Among these, it is preferred to use a lithium-based metal oxide of formula LiMO₂, wherein M is the same as defined above. Particularly preferred examples thereof may include LiCoO₂, LiNiO₂, LiNiₓCo₁₋ₓO₂ (0<x<1) and spinel-structured LiMn₂O₄,
(ii) a lithiated or partially lithiated transition metal oxyanion-based electro-active materials of formula M1M2 (JO₄)_{f}E_{1-f}, wherein M1 is lithium, which may be partially substituted by one or more other alkali metal representing less than 20% of the M1 metals, M2 is a transition metal at the oxidation level of +2 selected from Fe, Mn, Ni or mixtures thereof, which may be partially substituted by one or more additional metals at oxidation levels between +1 and +5 and representing less than 35% of the M2 metals, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1. The M₁M₂(JO₄)_{f}E_{1-f} electro-active material as defined above is preferably phosphate-based and may have an ordered or modified olivine structure. More preferably, the electro active compound in the case of forming a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electro active compound is a phosphate-based electro-active material of formula Li(FeₓMn₁₋ₓ)PO₄ wherein 0≤x≤1, wherein x is preferably 1 (that is to say, lithium iron phosphate of formula LiFePO₄),
(iii) lithium-containing complex metal oxides of general formula (III)

LiNiₓM1_{y}M2_{z}Y₂ (III)

wherein M1 and M2 are the same or different from each other and are transition metals selected from Co, Fe, Mn, Cr and V, 0.5≤x≤1, wherein y+z=1−x, and Y denotes a chalcogen, preferably selected from O and S.

The electro active material in this embodiment is preferably a compound of formula (III) wherein Y is O. In a further preferred embodiment, M1 is Mn and M2 is Co or M1 is Co and M2 is Al.

Examples of such active materials include LiNiₓMn_{y}Co_{z}O₂, herein after referred to as NMC, and LiNiₓCo_{y}Al_{z}O₂, herein after referred to as NCA. Specifically with respect to LiNiₓMn_{y}Co_{z}O₂, varying the content ratio of manganese, nickel, and cobalt can tune the power and energy performance of a battery.

In this embodiment of the present invention, the electro active material is preferably a compound of formula (III) as above defined, wherein 0.5≤x≤1, 0.1≤y≤0.5, and 0≤z≤0.5.

Non limitative examples of suitable electro active materials for positive electrode of formula (III) include, notably:
LiNi_{0.5}Mn_{0.3}Co_{0.2}O₂,
LiNi_{0.6}Mn_{0.2}Co_{0.2}O₂,
LiNi_{0.8}Mn_{0.1}Co_{0.1}O₂,
LiNi_{0.8}Co_{0.15}Al_{0.05}O₂,
LiNi_{0.8}Co_{0.2}O₂,
LiNi_{0.8}Co_{0.15}Al_{0.05}O₂,
LiNi_{0.6}Mn_{0.2}Co_{0.2}O₂
LiNi_{0.8}Mn_{0.1}Co_{0.1}O₂,
LiNI_{0.9}Mn_{0.05}Co_{0.05}O₂.

Among these the compounds:
LiNi_{0.8}Co_{0.15}Al_{0.05}O₂,
LiNi_{0.6}Mn_{0.2}Co_{0.2}O₂,
LiNi_{0.8}Mn_{0.1}Co_{0.1}O₂,
LiNI_{0.9}Mn_{0.05}Co_{0.05}O₂.
   are particularly preferred.

Electro active materials for an anode typically comprise one or more carbon-based materials and/or one or more silicon-based materials. In some embodiments, the carbon-based materials may be selected from graphite, such as natural or artificial graphite, graphene, or carbon black. These materials may be used alone or as a mixture of two or more thereof. The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

When present in the electro active material, the silicon-based compounds are comprised in an amount ranging from 1 to 60% by weight, preferably from 5 to 20% by weight with respect to the total weight of the electro active material.

Another component of the electrode material is a binder. The binder is an important component of electrodes because it has the role of ensuring good adhesion to the current collector and to the electro active materials, thus allowing the electro active materials to transfer electrons as required.

Typically the binder is a polymeric material. Suitable polymeric materials usable as binders are for example VDF based polymers, SBR rubbers, PAI polymers, saccharide based polymers (CMC, alginate, chitosan), polyacrylic acids and more. In the present invention preferably the binder comprises at least 50% wt of one or more VDF based polymers. This because VDF based polymers possess the best surface properties for allowing the pressurized gas to penetrate the surface and the pores, in particular when using CO₂ and supercritical CO₂.

For “VDF based polymer” it is intended a polymer or copolymer comprising a majority of recurring units derived from 1,1, difluoro ethylene (vinylidene difluoride, or VDF). VDF based polymers suitable for use in the present invention comprise at least 50%, preferably at least 70%, more preferably at least 80%, most preferably at least 90% by moles of recurring units derived from VDF. All percentages are based on the total amount of recurring units in the polymer.

VDF polymers suitable as binders in the present invention preferably comprise 0.1-10%, more preferably 0.2-7.5%, even more preferably 0.2-5% by moles, of recurring units which are derived from the polymerization of ethylenically unsaturated monomers including a polar group, preferably a carboxylic group. Examples of these non-fluorinated comonomers are notably hydrophilic (meth)acrylic monomers.

The hydrophilic (meth)acrylic monomer preferably complies to formula:

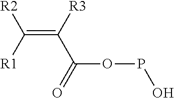

wherein each of R1, R2, R3, equal or different from each other, is independently a hydrogen atom or a C₁-C₃ hydrocarbon group, and R_{OH} is a hydrogen or a C₁-C₅ hydrocarbon moiety comprising at least one hydroxyl group. Non limitative examples of hydrophilic (meth)acrylic monomers are notably acrylic acid, methacrylic acid, hydroxyethyl (meth)acrylate, hydroxypropyl(meth)acrylate; hydroxyethylhexyl (meth)acrylates.

The hydrophilic (meth)acrylic monomer is more preferably selected from:
hydroxyethylacrylate (HEA) of formula:

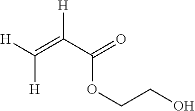

2-hydroxypropyl acrylate (HPA) of either of formulae:

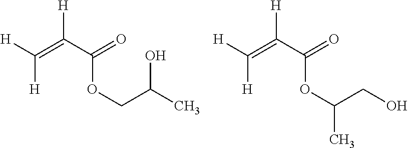

acrylic acid (AA) of formula:

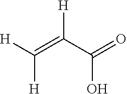

and mixtures thereof.

Most preferably, the hydrophilic (meth)acrylic monomer is AA and/or HEA.

Surprisingly it has been found that electrode materials comprising a binder which in turn comprises VDF polymers including polar comonomers as described, even if, as known in the art, such binders provide a higher adhesion to the current collector (se e.g. WO2008129041A1 from Solvay) can be recovered more easily and efficiently with the method of the present invention.

Binders comprising VDF polymers as described above are particularly suitable for use as binders in cathodes.

A typical composition for an electrode material includes 80% to 99% by weight of electro active materials, and 1 to 20% wt of binder, based on the total weight of electrode material.

In a second step of the process of the present invention the at least one electrode provided in the first step must be exposed to a gas or to a supercritical fluid at elevated pressure. In order to do so it is preferred that the electrode is fully unrolled and/or unfolded in a flattened configuration. If desired it can be cut into smaller pieces, however one of the advantages of the method of the present invention is that the electrodes can be subject to the method in their entirety without the necessity of cutting them previously.

The treatment at high pressure can be performed in any suitable equipment. Typically an autoclave will be used. Multiple layers of electrodes can be superimposed without negatively affecting the results of the method. Preferably, when multiple electrodes are treated at the same time the electrodes are of the same type i.e. all anodes or all cathodes. In order to minimize cross contamination of electrode materials it is further preferred that all electrodes subjected to high pressure at the same time use the same electrode material.

The choice of gas or supercritical fluid to be used in the present invention is not particularly critical because the main effect of the gas or supercritical fluid is mechanical. In other words the gas or supercritical fluid permeates the pores of the electrode materials and, when pressure is rapidly released the electrode material separates from the current collector. However some preferred gases or supercritical fluid may perform better being more effective in the separation process or requiring milder conditions. Preferred gas or supercritical fluid can be preferably selected so to have a certain affinity for the binder, in terms of polarity, and to be non-reactive with any of the components of the electrode. Preferred chemical compounds which can be used in the gas or supercritical fluid in the method of the present invention have a critical density in the range 0.470-0.220 g/ml. Examples of more preferred chemical compounds are for example CO₂, H₂O, CH₃OH, CH₃CH₂OH, (CH₃)₂CO, N₂O, NH₃. The use of NH₃ and in general of chemical compounds having basic properties although per se effective, is not advisable when the binder comprises a VDF based polymer as it can negatively interact with the binder. In case the binder comprises a VDF based polymer the other chemical compounds in the list are preferred over NH₃. One or more chemical compound can be used to build up the pressure, but it is preferred to use one. in general the autoclave will be sealed with air at atmospheric pressure and then one or more compounds are introduced building up the pressure. In some embodiments air can be removed from the autoclave before introducing the one or more chemical compound to build up the pressure. The treatment at high pressure is performed at a pressure from 60 to 300 bar, preferably from 90 to 270 bar, more preferably from 100 to 250 bar. The temperature at which the treatment is performed is not critical. In general it is preferred to operate at a temperature between 30 and 200° C. Clearly, depending on the material used, the temperature must be selected in such a way that a pressure in the desired range can be built up with the selected gas or supercritical fluid. E.g. for CO₂ suitable temperatures are 30 to 400° C.; for H₂O 100 to 700° C., for CH₃OH from 40 to 500° C. and for CH₃CH₂OH from 50 to 600° C.

The preferred chemical compound for use in the present invention to build up the pressure is CO₂ and even more preferably is supercritical CO₂ (i.e. CO₂ at temperature and pressure at which it is in supercritical conditions according to the CO₂ phase diagram).

In a preferred embodiment of the process of the invention, the electrodes, are contacted with a co-solvent before sealing the autoclave. This step has been found to facilitate the separation process. Without being bound to theory it is believed that wetting the electrode material with a co-solvent facilitates the penetration of the gas or the supercritical fluid within the pores of the material, and in particular in the pores at the junction between the electrode material and the current collector. Suitable co-solvents are water or mildly acidic water solutions, alcohol, liquid CO₂, linear or cyclic esters, polar aprotic solvents such as N-Methyl-pyrrolidone, dimethylsulfoxide, γ-valerolactone, γ-butyrolactone, diesters such as Rhodiasolv® RPDE. When CO₂ is used it may be introduced in the autoclave in solid form for easier handling, as it can turn to liquid and then gas/supercritical fluid state during the performance of the process at the conditions selected for the high pressure treatment. After the autoclave or other pressure resistant equipment is sealed the temperature is brought to the desired level and the pressure is increased typically via an inlet. Alternatively, or in combination with an inlet which can be used to control the pressure more precisely, the co-solvent may be selected and introduced in the autoclave in such an amount that, once the selected temperature is reached, said co-solvent is converted to a gas or supercritical fluid thus building up the desired pressure within the system.

It has been surprisingly found that the time of exposure to the selected temperature and pressure can be very brief because simply exposing the electrodes to high pressure allows the gas or the supercritical fluid to permeate the pores almost instantly. A longer exposure to the selected conditions can be beneficial in terms of ensuring a more complete penetration of the gas or supercritical fluid into the pores of the electrode material, and to be adsorbed onto the binder surface, but the advantages of a longer time of exposure tend to be lower and lower when increasing the exposure time, so that, preferably the exposure time can vary greatly from 0.1 seconds to 24 hours, but more preferably, for the economy of the process an exposure time between 0.1 second and 60 minutes is preferred.

A third step of the method of the invention is the rapid decrease of the pressure set in the previous step. When rapidly decreasing the pressure in the system, the gas (or the supercritical fluid) rapidly expands thereby causing the separation of the electrode material from the current collector foil.

Without being bound by theory it is believed that the gas or supercritical fluid penetrates in the pores of the electrode material and also may be superficially adsorbed by the polymeric binder.

If the pressure in the system is released rapidly, the gas or supercritical fluid expands very quickly before it can migrate out of the pores thereby causing a change in size and shape of the electrode material coating. This change in size and shape causes the complete loss of adhesion between the electrode material and the current collector. The current collector film typically can be recovered in undamaged form, while the electrode material can be collected in fragments and/or brushed away from the surface of the current collector.

As mentioned above, in order to obtain the desired effect the pressure release must happen very quickly so that a drop of at least 60 bar in 30 seconds or less is required. However in principle the faster and the larger is the pressure drop the more effective is the process. Therefore preferably the process may have a pressure drop of at least 90 bar in 30 seconds or less, even more preferably in 20 seconds or less, even more preferably in 10 seconds or less. In one embodiment the pressure is released from the maximum treatment pressure to ambient pressure in less than 30, preferably less than 20, more preferably less than 10 seconds.

The process of the invention is particularly advantageous because the current collector foil can be recovered in its entirety and reused as is, while the electrode material can be recovered separately and treated according one of the known methods in order to separate the electro-active materials from the binder (e.g. using a solvent for the binder). One of the advantages of the method of the invention is that contamination of the electrode material from the current collector is essentially zero. The process is environmentally friendly as the gas or supercritical fluids used can be entirely recovered and reused.

The process of the invention is particularly useful in recovering cathodes because the electro active materials of the cathodes (the Li based mixed oxides and salts) are the most valuable components of the battery and have high purity requirements so that their recycling has the utmost economic and environmental importance.

Should the disclosure of any patents, patent applications, and publications which are incorporated herein by reference conflict with the description of the present application to the extent that it may render a term unclear, the present description shall take precedence.

### EXAMPLES

### Example 1

3 flat cathodes (having dimensions 4×0.5 cm each) comprising an Al foil as current collector and cathode material comprising PVDF/AA binder (Solef® 5130) and LiNi_{0.8}Mn_{0.1}Co_{0.1}O₂ as electro active material, were been placed in a stainless steel autoclave having a volume of 100 mL. 14 g of solid CO₂ were added distributed on top of the cathodes. The autoclave was then closed and heated to 100° C. The CO₂ pressure was measured to be 95 bar and it was regulated to 100 bar using a CO₂ inlet. The selected pressure and temperature were maintained for 15 minutes and then the pressure was rapidly reduced to ambient pressure in 5 seconds by opening an outlet of the autoclave. The cathode material were found to be completely delaminated from the Al foil and could be recovered entirely. The Al foil was intact.

### Example 2

The same process of example 1 was used but 3 flat Anodes of the same size were used (Cu current collector and anode material graphite/silicon oxide with SBR binder). The anode material were found to be completely delaminated from the Cu foil. The Cu foil was intact.

1. A method for separating the electrode materials from the current collector in a battery electrode, said method comprising:
a—providing at least one electrode said electrode comprising a current collector and a layer of electrode material adhered onto said current collector, said layer of electrode material comprising electro active materials in powder form and a binder
b—contacting said electrode to a gas or a supercritical fluid at a pressure of 60 to 300 bar,
c—rapidly decreasing the pressure of said gas or supercritical fluid of at least 60 bar within 30 seconds or less thereby causing rapid decompression of said gas.

2. The method according to claim 1 wherein, in step b said electrodes are subject to a pressure of from 90 to 270 bar.

3. The method according to claim 1 wherein, in step c the pressure is rapidly decreased of at least 90 bar in 30 seconds or less.

4. The method according to claim 1 wherein, in step c the pressure is rapidly decreased from the maximum treatment pressure to ambient pressure in less than 30 seconds.

5. The method according to claim 1 wherein said at least one electrode is a cathode.

6. The method according to claim 1 wherein said electro active material comprises metallic oxides and salts including Li.

7. The method according to claim 1 wherein said electrode material comprises 80% to 99% by weight of electro active materials, and 1 to 20% wt of binder, based on the total weight of the electrode material.

8. The method according to claim 1 wherein said binder comprises one or more VDF based polymer.

9. The method according to claim 8 wherein said VDF based polymer comprises at least 50% by moles of recurring units derived from VDF and 0.1-10% moles, of recurring units derived from (meth)acrylic monomers of formula: 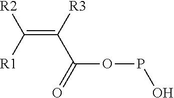
wherein each of R1, R2, R3, equal or different from each other, is independently a hydrogen atom or a C₁-C₃ hydrocarbon group, and R_{OH} is a hydrogen or a C₁-C₅ hydrocarbon moiety comprising at least one hydroxyl group.

10. The method according to claim 9 wherein said (meth)acrylic monomer is selected from acrylic acid, hydroxyethyl acrylate, hydroxypropyl acrylate and mixtures thereof.

11. The method according to claim 1 wherein said gas or supercritical fluid has a critical density in the range 0.470-0.220 g/ml.

12. The method according to claim 1 wherein said gas or supercritical fluid is selected from CO₂, H₂O, CH₃OH, CH₃CH₂OH, and (CH₃)₂CO.
